(19) United States
(12) Patent Application Publication
(10) Pub. No.: US 2023/0257947 A1
(43) Pub. Date: Aug. 17, 2023

(54) WASTE COLLECTION ATTACHMENT FOR VACUUM OF LEAF BLOWER AND METHOD OF USE

(71) Applicant: Marc R. Price, Prairie Village, KS (US)

(72) Inventor: Marc R. Price, Prairie Village, KS (US)

(21) Appl. No.: 18/137,644

(22) Filed: Apr. 21, 2023

Related U.S. Application Data
(63) Continuation-in-part of application No. 16/906,868, filed on Jun. 19, 2020.
(60) Provisional application No. 63/576,241, filed on Jan. 27, 2023.
(60) Provisional application No. 62/921,449, filed on Jun. 19, 2019.

(51) Int. Cl. E01H 1/12; A47L 9/14; A47L 5/14; A47L 5/24; A47L 9/06; A47L 9/12; A01G 20/47

(52) U.S. Cl. CPC E01H 1/1206; A47L 9/1418; A47L 9/1427; A47L 5/14; A47L 5/24; A47L 9/0673; A47L 9/122; A01G 20/47; E01H 2001/1226

(57) ABSTRACT

A waste collection device including a compartment for receiving pet waste or other waste. The device is attached to the end of a leaf blower, hand vacuum, or other device which provides suction. Accessories may be included which allow universal mounting to most or all types of vacuums and leaf blowers. A removable filter bag may be included for cleaner removal of waste.

### CROSS-REFERENCE TO RELATED APPLICATION

This application is a continuation-in-part and claims priority in U.S. patent application Ser. No. 16/906,868 filed Jun. 19, 2020, which claims priority in U.S. Provisional Patent Application No. 62/921,449 filed Jun. 19, 2019, and this application also claims priority in U.S. Provisional Patent Application No. 63/576,241 filed Jan. 27, 2023, all of which are incorporated herein by reference.

### BACKGROUND OF THE INVENTION

### 1. Field of the Invention

The present invention relates generally to an attachment and method for use thereof, and more specifically to a waste collection attachment which can be used with a leaf blower, handheld vacuum, wet dry vac, or any device which provides suction.

### 2. Description of the Related Art

Commonly, local laws, ordinances, or homeowners' associations require pet owners to remove and dispose of pet waste immediately or very soon after it is deposited. Even if a pet owner is not required by rule or regulation to remove pet waste, many pet owners prefer to remove it to maintain the cleanliness of their lawns, neighborhoods, and environment. Typically, pet waste is removed by using a bag, either with or without a shovel or scoop, to collect the waste. This activity requires the user to bend or stoop health wise, which they may not be permitted to do. This method is unpleasant and can result in the inadvertent transfer of waste to a user, which can be hazardous to the person's health. Further, because a plastic bag is often used, disposal can be environmentally detrimental.

Typically, devices for waste collection include shovels, scoops, bags, and other devices that require the user to have relatively good mobility and strength. Motorized devices are often heavy and/or bulky, difficult to transfer long distances, and require the user to have relatively good strength and flexibility. Even if the motorized devices are lighter in weight, each has its limitations. Commonly, motorized devices can be soiled during use and must be cleaned to eliminate undesirable odors and potential health risks from waste residue. Individuals that have arthritis, back pain, degenerative disc disease, coordination problems, poor eyesight, or other nerve or muscular problems that limit mobility can find cleaning up pet waste, debris, or other material by using such devices to be a particularly difficult task.

U.S. Pat. No. 10,022,026, which has the same inventor as the present application and is incorporated herein by reference, teaches a device aimed at picking up pet waste or other waste using suction. However, since most households already own an item which can provide vacuum suction such as a leaf blower vac, wet dry vac, or handheld vacuum, it may not be feasible to purchase an additional specialized device for the purposes of picking up waste. What is needed is a device which can provide the functionality of picking up waste such as pet waste while being usable with most or all existing vacuum-type devices while ensuring that the power tool remains clean.

Heretofore there has not been available a system or method for a waste collection device with the advantages and features of the present invention.

### BRIEF SUMMARY OF THE INVENTION

The present invention generally provides a waste collection device including a compartment for receiving pet waste or other waste. The device is attached to the end of a leaf blower, hand vacuum, wet dry vac, or other device which provides suction. Accessories may be included which allow universal mounting to most or all types of vacuums and wet dry vacs, leaf blowers vacs, or generally any powered tool capable of providing suction.

The leaf blower or vacuum device includes a motor and fan, along with other components, which provide air suction for drawing waste into the container. The leaf blower or vacuum may run on any common power type, from electricity, battery, to gasoline to solar energy. The vacuum or leaf blower vacuum may have a cord or be cordless and may have one-way suction or two-way blow/suction functionality.

In an embodiment affixed to a leaf blower vacuum, the leaf blower may have a telescopic tube or interlocking tubes which allow for extension of the distal end of the leaf blower. The compartment of the present invention could affix itself to any length of tube or simply to the end of the leaf blower vacuum itself for optimal universality.

By using this compartment with a vacuum device, including a leaf blower, wet dry vacs, the user's hands remain clean as the waste is deposited into the compartment. A bag and or filter may be included within the compartment to capture the waste, adding an additional layer of security between the user and the waste. Clips or other means of retaining the bag or filter in position may be employed within or on the exterior of the compartment. The bag captures waste and protects the power tool.

### BRIEF DESCRIPTION OF THE DRAWINGS

The drawings constitute a part of this specification and include exemplary embodiments of the present invention illustrating various objects and features thereof.

FIG. 1 is a three-dimensional diagram of a preferred embodiment of the present invention showing hidden features and elements in dashed lines.

FIG. 1A is a detailed three-dimensional diagram of a filter bag element thereof.

FIG. 2 is a three-dimensional diagram thereof showing the preferred embodiment of the present invention engaged in a typical environment of a hand-held vacuum using an attachment.

FIG. 3 is a three-dimensional diagram of the hand-held vacuum thereof.

FIG. 4 is a three-dimensional diagram of the attachment of FIG. 2.

FIG. 5 is a three-dimensional diagram of a typical environment consisting of a leaf blower or wet dry vac.

FIG. 6 is a three-dimensional diagram thereof showing the leaf blower affixed to the preferred embodiment of the present invention of FIG. 1.

FIG. 7 is a three-dimensional diagram of an alternative embodiment pet waste disposal attachment system.

FIG. 7A is a three-dimensional diagram thereof, shown with a bag inserted therein.

FIG. 8 is a three-dimensional diagram thereof, shown affixed to a hand-held vacuum cleaner.

FIG. 9 is a three-dimensional diagram thereof, shown affixed to a hand-held leaf blower.

FIG. 10 is a three-dimensional isometric view of another alternative embodiment pet waste disposal attachment system.

FIG. 10A is a three-dimensional isometric view thereof, shown with a bag inserted therein.

### DETAILED DESCRIPTION OF THE PREFERRED EMBODIMENTS

### I. Introduction and Environment

As required, detailed aspects of the present invention are disclosed herein, however, it is to be understood that the disclosed aspects are merely exemplary of the invention, which may be embodied in various forms. Therefore, specific structural and functional details disclosed herein are not to be interpreted as limiting, but merely as a basis for the claims and as a representative basis for teaching one skilled in the art how to variously employ the present invention in virtually any appropriately detailed structure.

Certain terminology will be used in the following description for convenience in reference only and will not be limiting. For example, up, down, front, back, right and left refer to the invention as orientated in the view being referred to. The words, “inwardly” and “outwardly” refer to directions toward and away from, respectively, the geometric center of the aspect being described and designated parts thereof. Forwardly and rearwardly are generally in reference to the direction of travel, if appropriate. Said terminology will include the words specifically mentioned, derivatives thereof and words of similar meaning.

### II. Preferred Embodiment Waste Collection Attachment 2

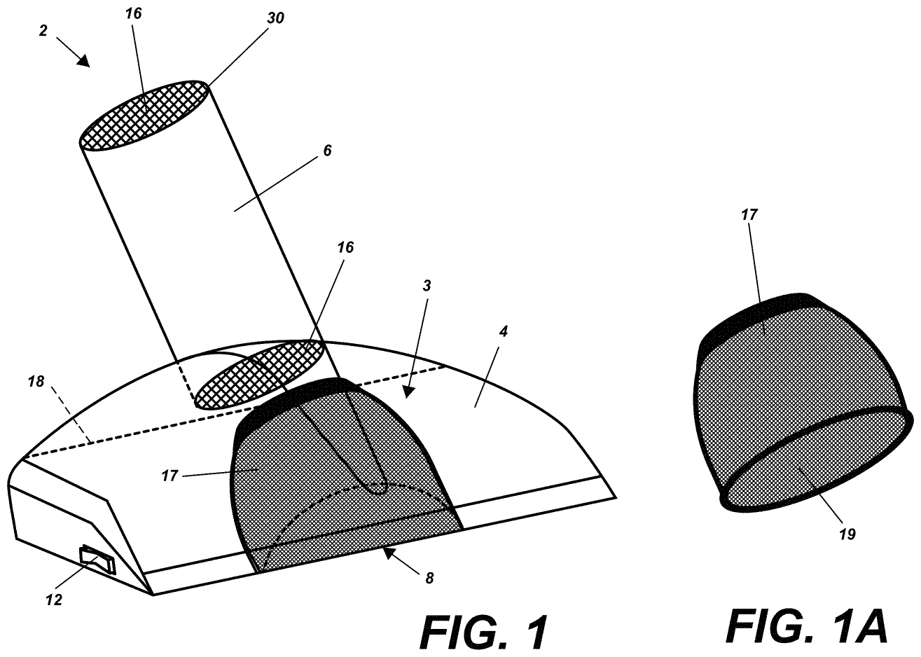

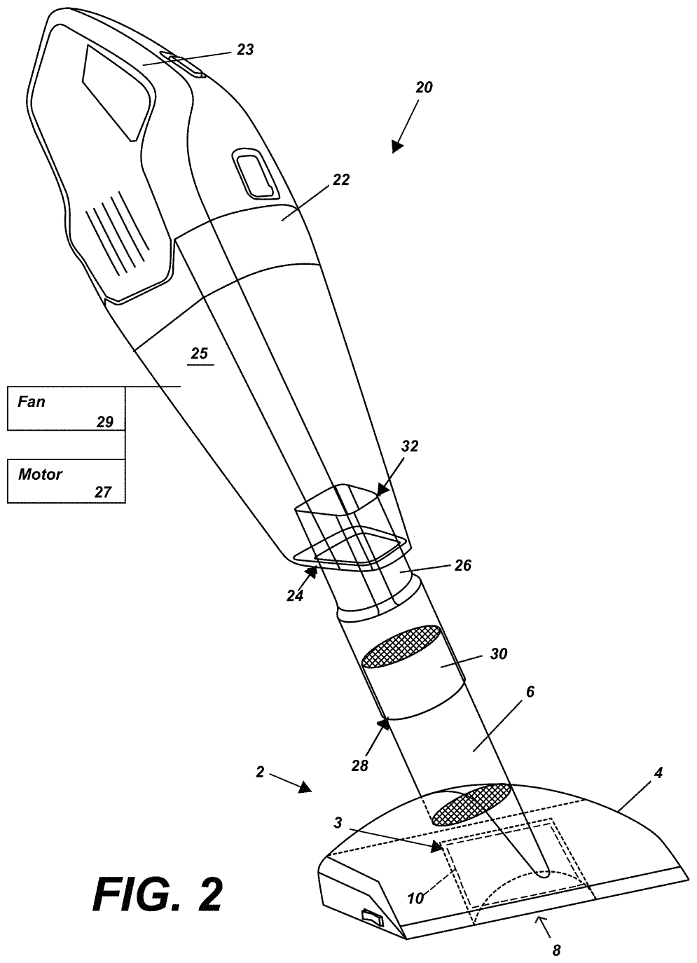

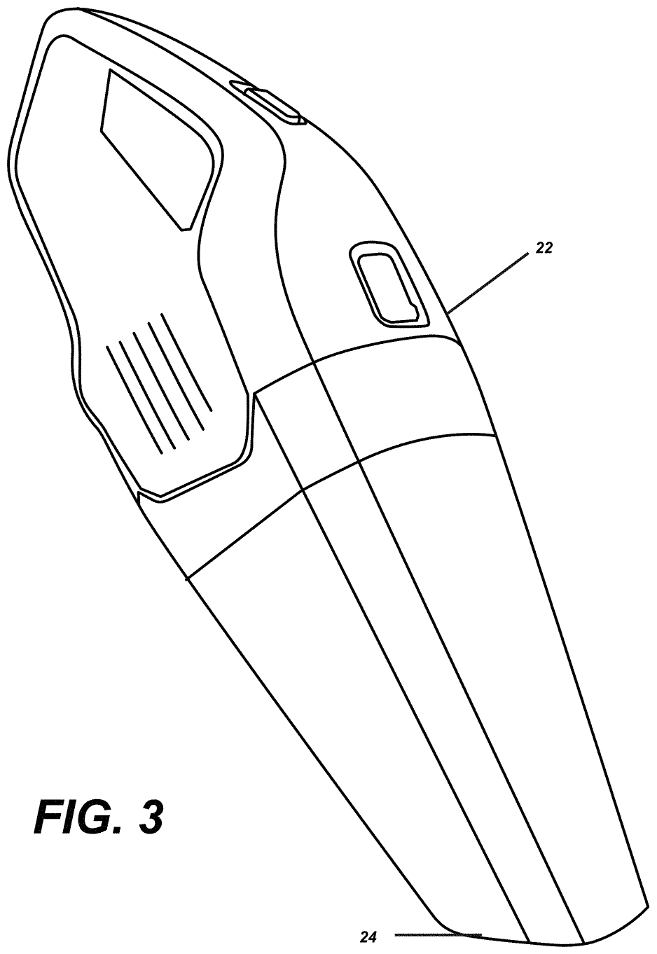

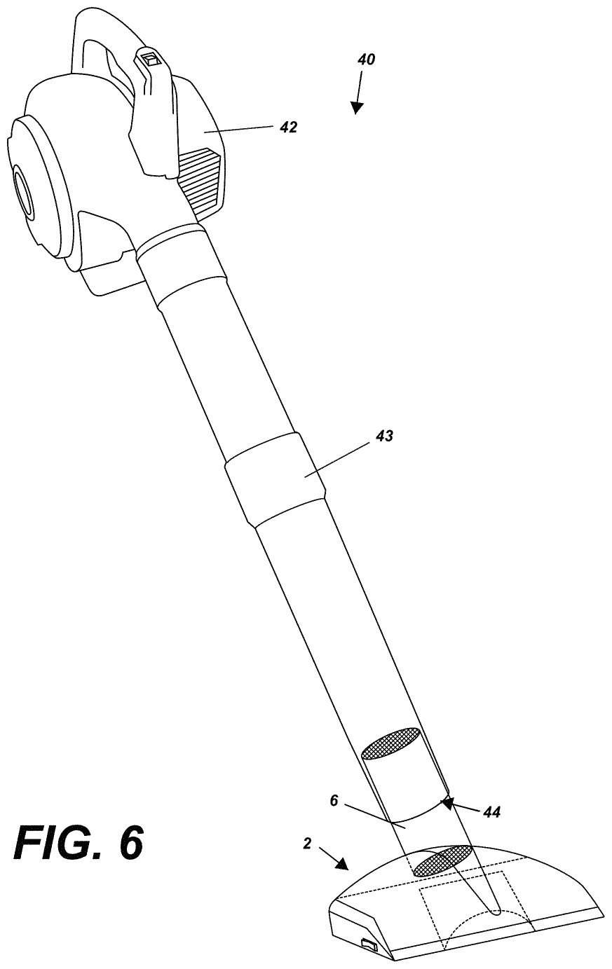

FIG. 1 shows a waste collection device 2 which has a base 4 housing an interior compartment 3, and a connector 6 for connecting the waste collection attachment 2 to a vacuum-capable device, such as a hand vacuum shown in FIGS. 2-3 or a leaf blower shown in FIGS. 5-6. Any suitable vacuum-capable device which has a motor 27, fan 29, housing 25, and handle 23 which, when attached to the waste collection device 2, makes it simple and easy to pick up waste such as pet waste. The base 4 could have lights, safety reflectors, or other features to aid the user in low-light areas.

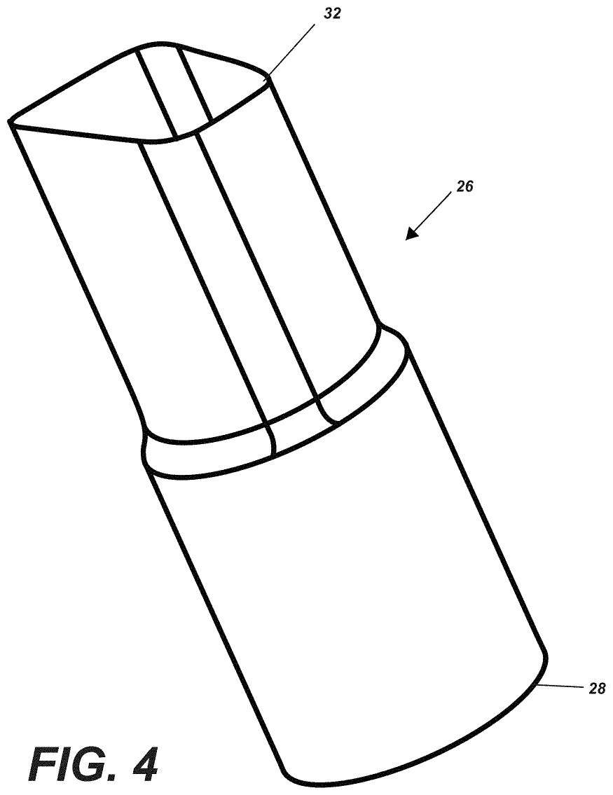

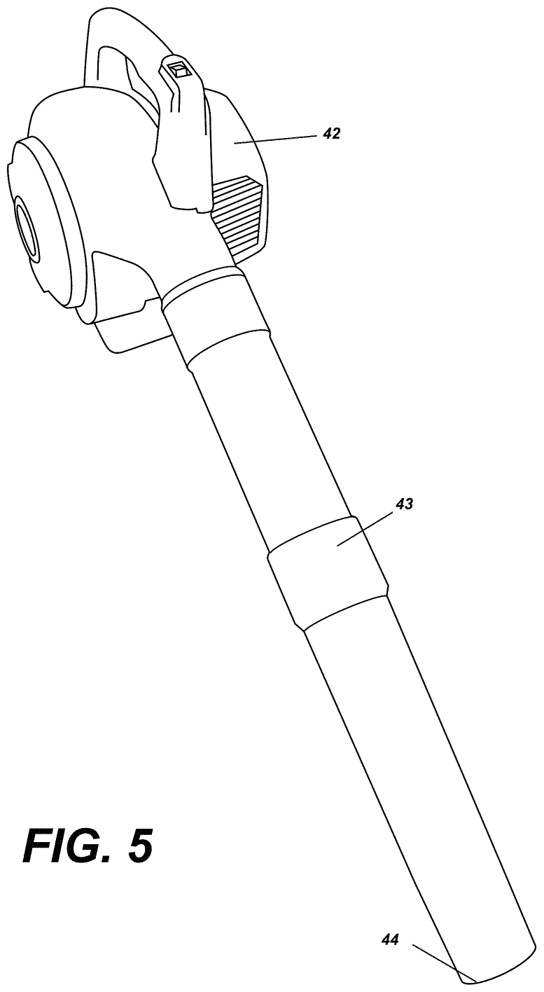

The waste collection device 2 has an opening 8 in the front of the base 4, a flap 10 for opening and cleaning the attachment, and an optional collection bag or filter 17 which further captures the waste and contains it for easy removal and cleaning. The bag or filter may also be disposable and thrown away. As shown in FIG. 1A, the filter/bag 17 has an opening 19 which receives the waste when it enters the base 4 through the opening 8. The entire base compartment front can be opened along a hinge 18 or other means of opening. A switch 12 can be used to lock or open the flap compartment. The connector 6 has a pair of mesh filter guards 16 for filters to prevent waste from being sucked into the vacuum device. The upper end 30 of the connector 6 connects to the vacuum device or an attachment which converts it for connecting to a vacuum device such as shown in FIG. 4.

As shown in FIG. 2, the waste collection device 2 can be connected to a hand vacuum 22 to form a waste collection vacuum 20. An attachment 26 connects the connector 6 to the end 24 of the vacuum 22. The upper end 32 of the attachment 26 is inserted into the end 24 of the vacuum as shown to secure it into place, and the lower end 28 of the attachment 26 connects to the upper end 30 of the connector 6. When the vacuum 22 is turned on, suction pulls waste into the opening 8 of the waste collection attachment 2, which is stored within the compartment base 4 or within an optional filter or bag 17. FIG. 3 shows the vacuum by itself. FIG. 4 shows the attachment 26 by itself. A number of attachments may be used to make the waste collection device 2 universally connectable to any vacuum device. Alternatively, the attachment 26 could have flexible or adjustable ends to fit vacuums and/or leaf blowers universally.

FIG. 5 shows a standard leaf blower 42 which has a tube 43 with a tube end 44. The tubes do not have to be connected to the leaf blower 42 for attachment to the waste collection device 2, but may be used to extend reach. The leaf blower 42 must be capable of performing suction.

FIG. 6 shows the leaf blower 42 connected to the waste collection device 2 by connecting the connector 6 to the end 44 of the tube 43, thereby creating a waste collection vacuum 40.

### III. Alternative Embodiment Pet Waste Attachment System 102

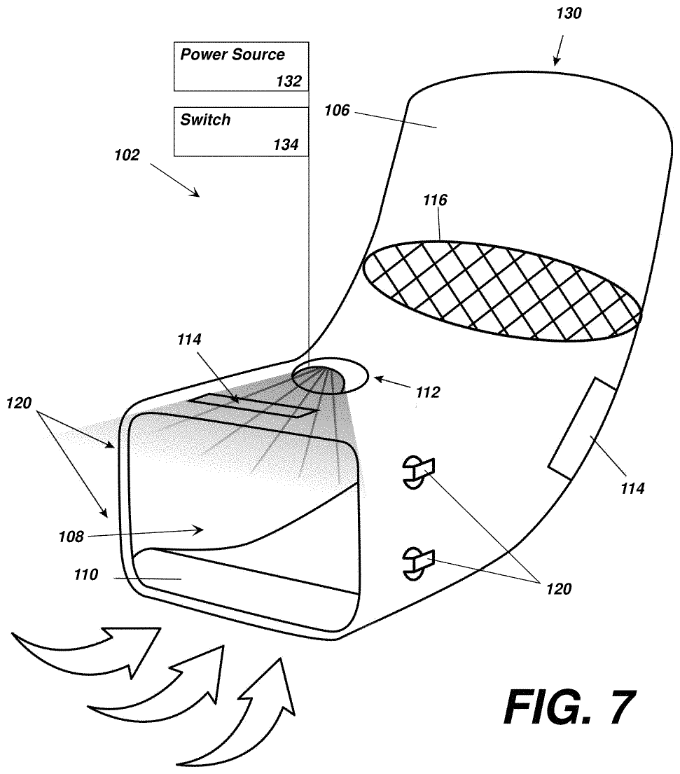

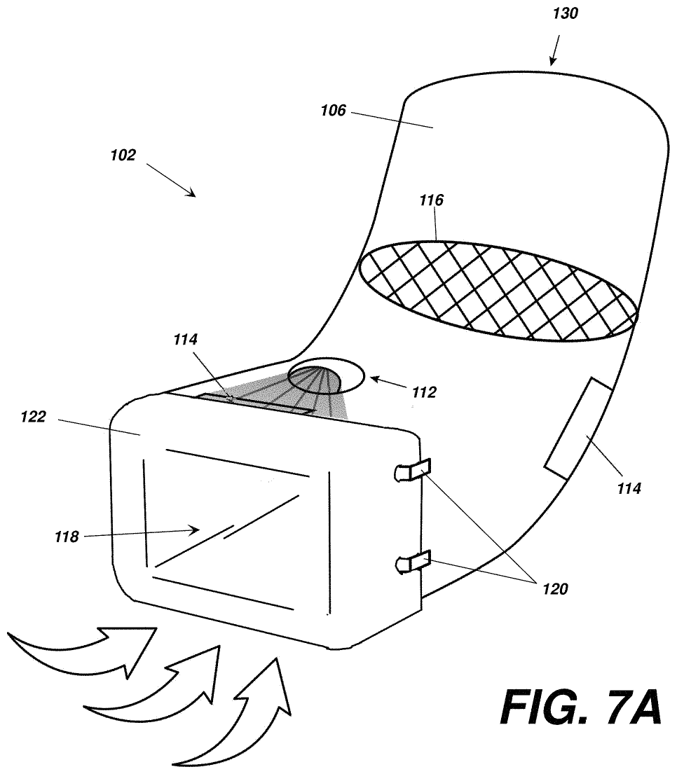

FIGS. 7-9 show an alternative embodiment pet waste attachment system 102 which has a connector 106 having an upper opening 130 designed to be fit to a device capable of providing suction, such as a vacuum cleaning device or leaf blower device. An attachment such as that shown in FIG. 4 may be used between the upper opening 130 and the device.

The front opening 108 of the pet waste attachment system 102 receives the pet waste as described in the embodiment above. A raised bar lip 110 at the forefront of the front opening 108 prevents a bag inserted into the opening from falling out after use. Side wing retention clips 120 located on either side of the front opening 108 further secure the bag in place within the opening or side wings. Both ways hold the bag from being pulled inside the power tool. Reflectors 114 may be located around the exterior of the device, and a light source 112 may also be included for night vision pickup. A light source can also be placed on the power tool. As with the embodiment above, a filter guard 116 may be placed within the connector 106.

The light source 112 can include a power switch 134 and a connection to a power source 132. This power source could be any suitable power source, including a solar panel, a battery, or even a power tool such as a hand vacuum cleaner 20 or leaf blower 42.

FIG. 7A shows the pet waste attachment system 102 with a bag 122 having an opening 118 which is placed within the front opening 108 and secured via the retention clips 120. A space is shown between the filter guard 116 and the front opening of the bag 122 and device such that it allows expansion of the bag into the interior of the device.

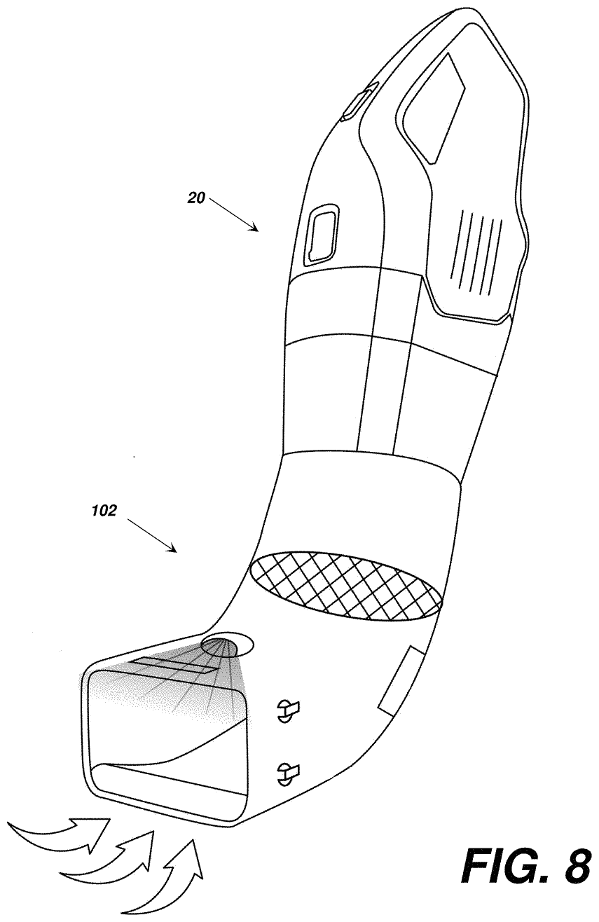

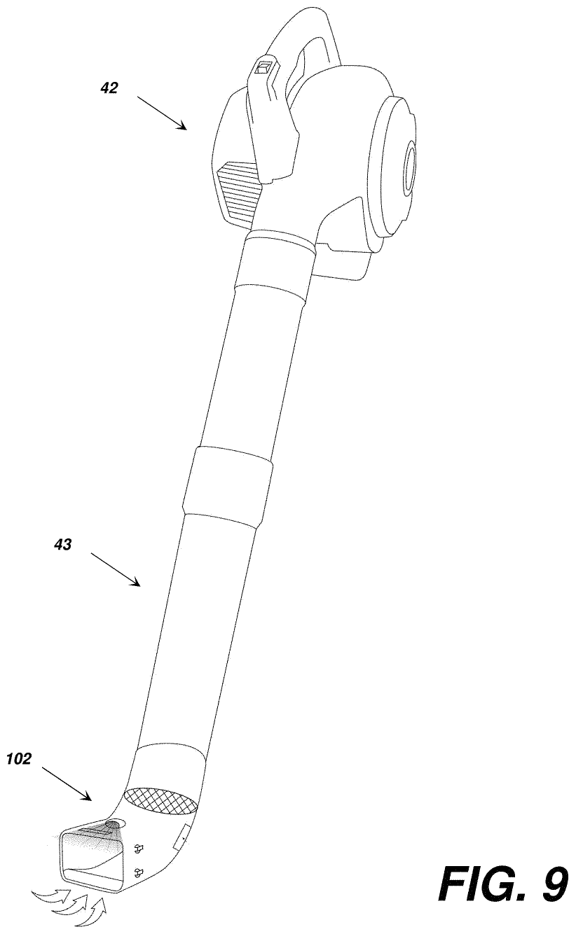

FIG. 8 shows the pet waste attachment system 102 connected to a hand-held vacuum cleaner 20. FIG. 9 similarly shows the pet waste attachment system 102 connected to a leaf blower 42 via an extension attachment 43.

### IV. Alternative Embodiment Pet Waste Attachment System 152

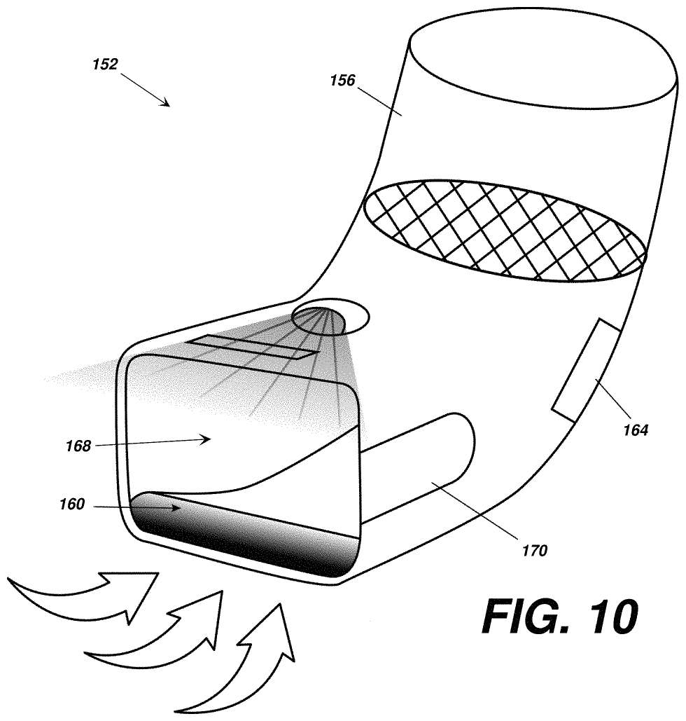

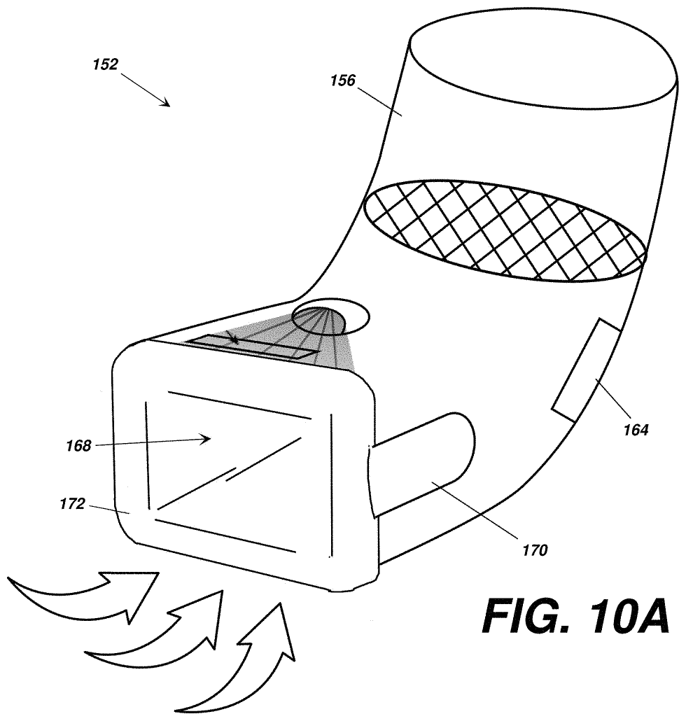

Much like the previous embodiment, FIGS. 10 and 10A show a slightly alternative embodiment pet waste attachment system 152 with a similar front opening 108 having a similar raised bar lip 160, reflectors 164, and connector 156 for connection with a suction-providing powered device. Instead of the wing retention clips of the prior embodiment, the embodiment shown in FIGS. 10 and 10A include a side wing retention bar 170 which can secure the side of the bag 172 which can be inserted into the front opening 108, the bag 172 having its own opening 168.

It is to be understood that while certain embodiments and/or aspects of the invention have been shown and described, the invention is not limited thereto and encompasses various other embodiments and aspects.

Having thus described the invention, what is claimed as new and desired to be secured by Letters Patent is:

1. A portable vacuum system comprising:
a waste collection device comprising an opening, an interior compartment, and a connector having an open receiving end;
a portable vacuum device comprising a handle, a motor having a fan, and an open end configured for sucking waste and debris into said portable vacuum device;
said portable vacuum device open end configured to be temporarily connected to said open receiving end of said connector of said waste collection device;
said waste collection device configured to intake waste within said interior compartment via said opening when said portable vacuum device is operated; and
wherein said waste collection device and said portable vacuum device are selectively separable.

2. The portable vacuum system of claim 1, further comprising an attachment placed between said open receiving end of said waste collection device and said portable vacuum device open end, said attachment configured to connect said waste collection device to said portable vacuum device.

3. The portable vacuum system of claim 1, wherein said interior compartment is selectively openable along a hinge.

4. The portable vacuum system of claim 1, wherein said opening of said waste collection device comprises a flap.

5. The portable vacuum system of claim 1, further comprising a collection bag within said interior compartment, said collection bag configured to receive and store waste entering said waste collection device.

6. The portable vacuum system of claim 5, further comprising said open end comprising a raised bar lip configured to secure said bag within said interior compartment.

7. The portable vacuum system of claim 5, further comprising a securing element for securing sides of said bag to an exterior face of said waste collection device, said securing element selected from a list of securing elements comprising: side wing retention clips; hinged clips; snaps; straps; ties; side wing retention bars; and adhesives.

8. The portable vacuum system of claim 1, further comprising at least one filter guard located within said connector of said waste collection device.

9. A waste collection device for a portable vacuum device, the attachment device comprising:
an opening, an interior compartment, and a connector having an open receiving end;
said connector configured to connect the waste collection device to the portable vacuum device;
the waste collection device configured to intake waste within said interior compartment via said opening when said portable vacuum device is operated; and
wherein said waste collection device and said portable vacuum device are selectively separable.

10. The portable vacuum system of claim 9, further comprising an attachment placed between said open receiving end of said waste collection device and said portable vacuum device open end, said attachment configured to connect said waste collection device to said portable vacuum device.

11. The portable vacuum system of claim 9, wherein said interior compartment is selectively openable along a hinge.

12. The portable vacuum system of claim 9, wherein said opening of said waste collection device comprises a flap.

13. The portable vacuum system of claim 9, further comprising a collection bag within said interior compartment, said collection bag configured to receive and store waste entering said waste collection device.

14. The portable vacuum system of claim 9, further comprising at least one filter guard located within said connector of said waste collection device.

15. A portable waste collection system comprising:
a waste collection device comprising an opening, an interior compartment, and a connector having an open receiving end and at least one filter guard;
a portable vacuum device comprising a handle, a motor having a fan, and an open end configured for sucking waste and debris into said portable vacuum device;
said portable vacuum device open end located distally from said handle, and said open end configured to be temporarily connected to said open receiving end of said connector of said waste collection device;
said waste collection device configured to intake waste within said interior compartment via said opening when said portable vacuum device is operated;
wherein the vacuum device is operable with one hand; and
wherein said waste collection device and said portable vacuum device are selectively separable.

16. The portable vacuum system of claim 15, further comprising an attachment placed between said open receiving end of said waste collection device and said portable vacuum device open end, said attachment configured to connect said waste collection device to said portable vacuum device.

17. The portable vacuum system of claim 15, wherein said interior compartment is selectively openable along a hinge.

18. The portable vacuum system of claim 15, wherein said opening of said waste collection device comprises a flap.

19. The portable vacuum system of claim 15, further comprising a collection bag within said interior compartment, said collection bag configured to receive and store waste entering said waste collection device.

20. The portable vacuum system of claim 15, further comprising at least one filter guard located within said connector of said waste collection device.
